(19) United States
(12) Patent Application Publication
(10) Pub. No.: US 2011/0200284 A1
(43) Pub. Date: Aug. 18, 2011

(54) Fiber Optic Jack with High Interface Mismatch Tolerance

(76) Inventors: Igor Zhovnirovsky, Newton, MA (US); Subhash Roy, Lexington, MA (US)

(21) Appl. No.: 12/793,513

(22) Filed: Jun. 3, 2010

Related U.S. Application Data
(63) Continuation-in-part of application No. 12/784,849, filed on May 21, 2010.
Application No. 12/784,849 is a continuation-in-part of application No. 12/756,087, filed on Apr. 7, 2010.
Application No. 12/756,087 is a continuation-in-part of application No. 12/652,705, filed on Jan. 5, 2010.
Application No. 12/652,705 is a continuation-in-part of application No. 12/581,799, filed on Oct. 19, 2009.
Application No. 12/581,799 is a continuation-in-part of application No. 12/483,616, filed on Jun. 12, 2009.

(51) Int. Cl. G02B 6/32; G02B 6/36

(52) U.S. Cl. 385/33; 385/93

(57) ABSTRACT

A fiber optic connector jack is provided with a backcap processing module. The jack includes a lens housing having a lensed lid. A connector flange extends from the lensed lid top surface, shaped to selectively engage a plug connector housing. A microlens having a first surface is formed in the lensed lid bottom surface. A convex surface is formed in the lensed lid top surface to transceive light in a collimated beam with a plug optical interface. A backcap enclosure wall extends from the lensed lid bottom surface. The jack also includes a backcap processing module with a circuit substrate and an optical element. The optical element (e.g., a laser diode or photodiode) has an optical interface formed in a focal plane of the microlens to transceive light with the microlens first surface. An electrical connector and electrical cable selectively engages a printed circuit board with the circuit substrate.

### RELATED APPLICATIONS

This application is a Continuation-in-Part of a pending application entitled, FIBER OPTIC CABLE WITH HIGH INTERFACE MISMATCH TOLERANCE, invented by Igor Zhovnirovsky et al., Ser. No. 12/784,849, filed May 21, 2010, attorney docket no. applied_{—}321_CIP2;

which is a Continuation-in-Part of a pending application entitled, PUNCH-DOWN FIBER OPTIC CABLE TERMINATION, invented by Igor Zhovnirovsky et al., Ser. No. 12/756,087, filed. Apr. 7, 2010, attorney docket no. applied_{—}352:

which is a Continuation-in-Part of a pending application entitled, CONNECTOR JACK PROCESSING BACKCAP, invented by Igor Zhovnirovsky et al., Ser. No. 12/652,705, filed Jan. 5, 2010, attorney docket no. applied_{—}354:

which is a Continuation-in-Part of a pending application entitled, OFF-AXIS MISALIGNMENT COMPENSATING FIBER OPTIC CABLE INTERFACE, invented by Igor Zhovnirovsky et al., Ser. No. 12/581,799, filed Oct. 19, 2009, attorney docket no. applied_{—}321_CIP1;

which is a Continuation-in-Part of a pending application entitled, FIBER OPTIC CABLE INTERFACE, invented by Igor Zhovnirovsky et al., Ser. No. 12/483,616, filed Jun. 12, 2009, attorney docket no. applied_{—}321. All the above-referenced applications are incorporated herein by reference.

### BACKGROUND OF THE INVENTION

1. Field of the Invention

This invention generally relates to optical cables and, more particularly, to a fiber optical connector jack with backcap processing, which uses a microlens to transceive light in a collimated beam.

2. Description of the Related Art

Conventionally, optical fiber connectors are spring-loaded. The fiber endfaces (optical interfaces) of the two connectors are pressed together, resulting in a direct glass to glass or plastic to plastic, contact. The avoidance of glass-to-air or plastic-to-air interfaces is critical, as an air interface results in higher connector losses. However, the tight tolerances needed to eliminate an air interface make these connectors relatively expensive to manufacture.

FIG. 1 is a partial cross-sectional view of a Transmission Optical SubAssembly (TOSA) optical cable plug (prior art). The plug 100 is made from a plastic housing 102 with a bored ferrule 106 to secure an optical fiber 108. The plug 100 also includes a plastic lens 110, manufactured as a subassembly, integrated into the plug. The lens 110 has a curved surface to create a focal plane where the plug mates with a jack 112. The lens permits a low loss air gap to be formed between the plug and a connecting jack. In addition to the expense of manufacturing a 2-part plug, the plug must be made to relatively tight tolerances, so that the lens focal plane aligns with the jack, which also increases the cost of the plug.

FIG. 2 is a partial cross-sectional view of an 8 Position 8 Contact (8P8C) interface (prior art). The ubiquitous 8P8C connector is a hardwired electrical connector used commercially and residentially to connect personal computers, printers, and routers. The 8P8C is often referred to as RJ45. Although the housing/body can be made as a one-piece plastic molding, the spring-loaded contacts and the necessity of cable crimping add to the complexity of manufacturing the part. Advantageously however, the spring-loaded contacts permit the part to be made to relatively lax tolerances.

As noted in Wikipedia, plastic optical fiber (POF) is an optical fiber which is made out of plastic. Conventionally, poly(methyl methacrylate) (PMMA), a transparent thermoplastic (acrylic) alternative to glass, is the core material, and fluorinated polymers are the cladding material. Since the late 1990s however, much higher-performance POF based on perfluorinated polymers (mainly polyperfluorobutenylvinylether) has begun to appear in the marketplace.

In large-diameter fibers, 96% of the cross section is the core that allows the transmission of light. Similar to conventional glass fiber, POF transmits light (or data) through the core of the fiber. The core size of POF is in some cases 100 times larger than glass fiber.

POF has been called the “consumer” optical fiber because the fiber and associated optical links, connectors, and installation are all inexpensive. The conventional PMMA fibers are commonly used for low-speed, short-distance (up to 100 meters) applications in digital home appliances, home networks, industrial networks (PROFIBUS, PROFINET), and car networks (MOST). The perfluorinated polymer fibers are commonly used for much higher-speed applications such as data center wiring and building LAN wiring.

For telecommunications, the more difficult-to-use glass optical fiber is more common. This fiber has a core made of germania-doped silica. Although the actual cost of glass fibers is lower than plastic fiber, their installed cost is much higher due to the special handling and installation techniques required. One of the most exciting developments in polymer fibers has been the development of microstructured polymer optical fibers (mPOF), a type of photonic crystal fiber.

In summary, POF uses PMMA or polystyrene as a fiber core, with refractive indices of 1.49 & 1.59, respectively. The fiber cladding overlying the core is made of silicone resin (refractive index ˜1.46). A high refractive index difference is maintained between core and cladding. POF have a high numerical aperture, high mechanical flexibility, and low cost.

Generally, POF is terminated in cable assembly connectors using a method that trims the cables, epoxies the cable into place, and cures the epoxy. ST style connectors, for example, include a strain relief boot, crimp sleeve, and connector (with ferrule). The main body of the connector is epoxied to the fiber, and fiber is threaded through the crimp sleeve to provide mechanical support. The strain relief boot prevents to fiber from being bent in too small of a radius. Some connectors rely upon the connector shape for mechanical support, so a crimp sleeve is not necessary.

First, the strain relief boot and crimp sleeve are slid onto the cable. A jacket stripping tool must be used to remove the end portion of the fiber, exposing an aramid yarn (e.g., Kevlar™) covered buffer or cladding layer. Next, a buffer stripping tool is used to remove a section of the buffer layer, exposing the core. After mixing, a syringe is filled with epoxy. A bead of epoxy is formed at the end of the ferrule, and the ferrule back-filled with epoxy. The exposed fiber core is threaded through the connector ferrule with a rotating motion, to spread the epoxy, until the jacket meets the connector. At this point the crimping sleeve is slide onto the connector body and crimped in two places. Then, the strain relief boot can be slide over the crimp sleeve. After the epoxy cures, the core extending through the ferrule is polished with a lapping film. Then, the core is scribed at the point where it extends from the epoxy bead. The extending core portion is then cleaved from the connector and polished in multiple steps.

It is known to convert electrical signals to optical ones by adding laser diodes to a printed circuit board (PCB) for the purpose of transmission, and photodiodes to the PCB for the purpose of receiving. In this manner, optical signals may be used to communicate between electronic modules. However, one version of PCB must be explicitly designed dedicated to optical communications, as described above, while another version of the PCB is designed for the communication of electrical signals. It would be more desirable if the PCB could be designed with just electrical connectors, and the optical conversion optionally performed in the connector.

It would be advantageous if an optical connector jack existed that converted between optical and electrical signals.

It would be advantageous if the above-mentioned optical cable jack could be made more inexpensively with a relaxed set of mechanical and optical tolerances.

### SUMMARY OF THE INVENTION

According, a fiber optic connector jack is provided with a backcap processing module. The jack includes a lens housing having a lensed lid with a top surface and a bottom surface. A connector flange extends from the lensed lid top surface, and is shaped to selectively engage and disengage with a plug connector housing. A microlens having a first surface is formed in the lensed lid bottom surface and a convex surface is formed in the lensed lid top surface to transceive light in a collimated beam with a plug optical interface. A backcap enclosure wall extends from the lensed lid bottom surface. The jack also includes a backcap processing module with a circuit substrate and an optical element. The optical element (e.g., a laser diode or photodiode) has an electrical interface connected to the circuit substrate and an optical interface formed in a focal plane of the microlens to transceive light with the microlens first surface. An electrical connector, external to the backcap processing module, selectively engages and disengages from a printed circuit board (PCB) socket. An electrical cable carries electrical signals between the circuit substrate and the electrical connector, and a cap overlies the backcap enclosure walls.

Additional details of the above-described fiber optical jack are provided below.

### BRIEF DESCRIPTION OF THE DRAWINGS

FIG. 1 is a partial cross-sectional view of a Transmission Optical SubAssembly (TOSA) optical cable plug (prior art).

FIG. 2 is a partial cross-sectional view of an 8 Position 8 Contact (8P8C) interface (prior art).

FIG. 3 is a diagram depicting a fiber optic cable.

FIGS. 4A and 4B are a more detailed depiction of the first plug microlens of FIG. 3.

FIGS. 5A and 5B are partial cross-sectional and plan views, respectively, of the first plug of FIG. 3.

FIG. 6 is a partial cross-sectional view of the first plug microlens of FIG. 3.

FIGS. 7A and 7B are drawings depicting a fiber optic cable with a cable section that includes a first plurality of fiber optic lines.

FIG. 8 is a diagram depicting communicating jack and plug microlens.

FIG. 9 is a model calculation graphically depicting the coupling efficiency of the system of FIG. 8.

FIG. 10 is a diagram depicting the fiber core acceptance angle.

FIG. 11 is a graph depicting the relationship between coupling efficiency and fiber lateral decentering (Δ).

FIG. 12 is a diagram depicting the effective focal length of the plug microlens.

FIG. 13 is a table of tolerances cross-referenced to fiber lateral decentering.

FIG. 14 is a graph depicting coupling efficiency as a function of photodiode (PD) decentering.

FIG. 15 is a diagram depicting the relationship between fiber decentering and lens tilt.

FIG. 16 is a diagram depicting the relationship between PD decentering and lens tilt.

FIG. 17 is a diagram depicting the relationship between PD decentering and groove (channel) placement error.

FIG. 18 is a diagram depicting the consequences of shortening the focal length of the plug, without a corresponding change in the jack lens.

FIG. 19 is a flowchart illustrating a method for transceiving a collimated beam of light with a fiber optic cable jack connector.

FIG. 20 is a partial cross-sectional view depicting a fiber optic jack with backcap processing module.

FIG. 21 is a diagram depicting a first variation of the connector jack of FIG. 20.

FIG. 22 is a diagram depicting a second variation of the connector jack of FIG. 20.

FIGS. 23A and 23B are a more detailed depiction of the plug microlens of FIG. 20.

FIGS. 24A and 24B are plan and cross-sectional views, respectively, of a third variation of the jack of FIG. 20.

FIG. 25 is a cross-sectional view of a fourth variation of the jack of FIG. 20.

FIG. 26 is a cross-sectional view of a fifth variation of the jack of FIG. 20.

FIG. 27 is a cross-sectional view of a sixth variation of the jack of FIG. 20.

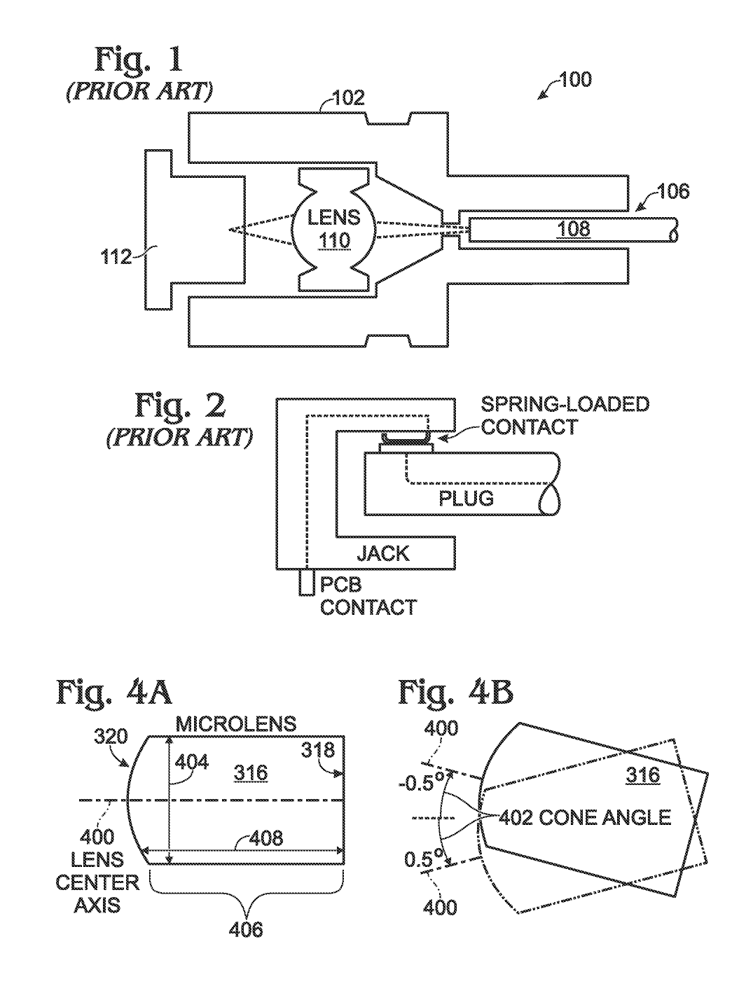

### DETAILED DESCRIPTION

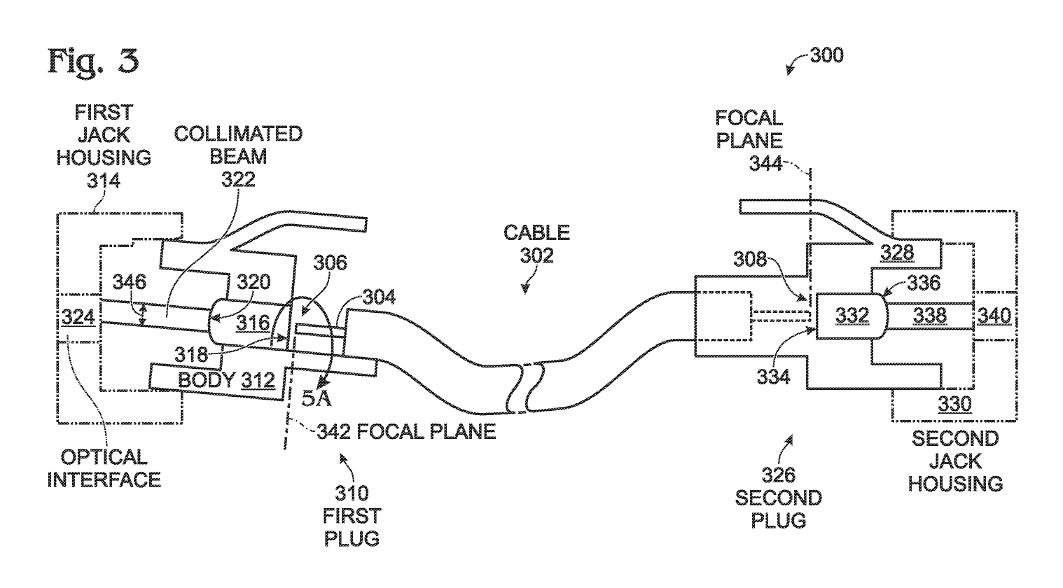

FIG. 3 is a diagram depicting a fiber optic cable. The fiber optic cable 300 comprises a cable section 302 including at least one length of fiber optic line or core 304 having a first end 306 and a second end 308. A first plug 310 includes a mechanical body 312 shaped to selectively engage and disengage a first jack housing 314 (shown in phantom), and a microlens 316. As defined herein, the plug is mechanically engaged with the jack when the plug is fully inserted into the jack. In some aspects, a locking mechanism is enabled when the plug and jack are mechanically engaged. An RJ-45 connector is one example of such a locking type mechanical engagement (as shown). In other aspects, mechanical engagement is obtained with a pressure or friction type fit. A universal serial bus (USB) connector, microUSB, HDMI, and DisplayPort are some examples of a pressure/friction type of mechanical engagement. Alternately stated, a plug and jack are mechanically engaged when they are mated sufficiently to perform their intended electrical or optical functions.

The first plug microlens 316 has a planar surface 318 to engage the fiber optic line first end 306 and a convex surface 320 to transceive light in a first collimated beam 322 with a first jack optical interface 324. Likewise, a second plug 326 includes a mechanical body 328 shaped to selectively engage and disengage a second jack housing 330 (shown in phantom), and a microlens 332. The second plug microlens 332 has a planar surface 334 to engage the fiber optic line second end 308 and a convex surface 336 to transceive light in a second collimated beam 338 with a second jack optical interface 340.

A collimated beam is light whose rays are parallel, and therefore the beam spreads slowly as it propagates. Laser light from gas or crystal lasers is naturally collimated because it is formed in an optical cavity between two mirrors, in addition to being coherent. However, diode lasers do not naturally emit collimated light, and therefore collimation into a beam requires a collimating lens. A perfect parabolic mirror will bring parallel rays to a focus at a single point. Conversely, a point source at the focus of a parabolic mirror will produce a beam of collimated light. Spherical mirrors are easier to make than parabolic mirrors and they are often used to produce approximately collimated light. Many types of lenses can also produce collimated light from point-like sources.

The fiber optic cable first end 306 is formed in a focal plane 342 of the first plug microlens 316, and the fiber optic cable second end 308 is formed in a focal plane 344 of the second plug microlens 332. In one aspect, the first and second plug. microlenses 316/332 are made from a polycarbonate resin thermoplastic such as lexan or ultem, and have respective focal lengths 342 and 344 in the range of 2 to 4 mm. The first and second plug microlens 316 and 332 transceive the collimated beams with a beam diameter 346 in the range of 1.2 to 1.3 mm.

As used herein, a jack is the “female” connector and a plug is a mating “male” connector. Note, a portion of the first plug body has been cut away to show the fiber line 304. In some aspects, a crimping plate is connected to a cradle portion of the body, to hold the fiber line in place. See parent application Ser. No. 12/581,799 for additional details.

FIGS. 4A and 4B are a more detailed depiction of the first plug microlens of FIG. 3. For clarity, only the microlens 316 is shown. The first plug microlens 316 has a lens center axis 400. As shown in FIG. 4B, there is a lens axis tolerance defined by a cone angle 402 of up to 0.5 degrees (+/−0.5 degrees from a perfectly aligned, or tolerance midpoint lens center axis) as a result of the first plug mechanical body tolerances, when engaging the first jack mechanical body. That is, due to “play” between the jack and plug housings, resulting from design and manufacturing tolerances, the lens axis may be misaligned as much as 0.5 degrees. Note: although misalignment is only shown in an XY plane, the lens axis tolerance may define a circular cone with respect to a perfectly aligned center axis.

The first plug microlens has a diameter 404 in the range of 2 to 3 mm, and the first collimated beam diameter (see FIG. 3, reference designator 346) is transceived within the microlens diameter 404. The first plug microlens 316 includes a cylindrical section 406 interposed between the planar surface 318 and the convex surface 320.

In one aspect, the first plug microlens cylindrical section 406 has a length 408 in the range of 4 to 6 mm and the convex surface 320 has a radius of curvature in the range of 1.5 to 2.5 mm. The second plug microlens, not shown, has the same lens dimensions and tolerances as the first plug microlens.

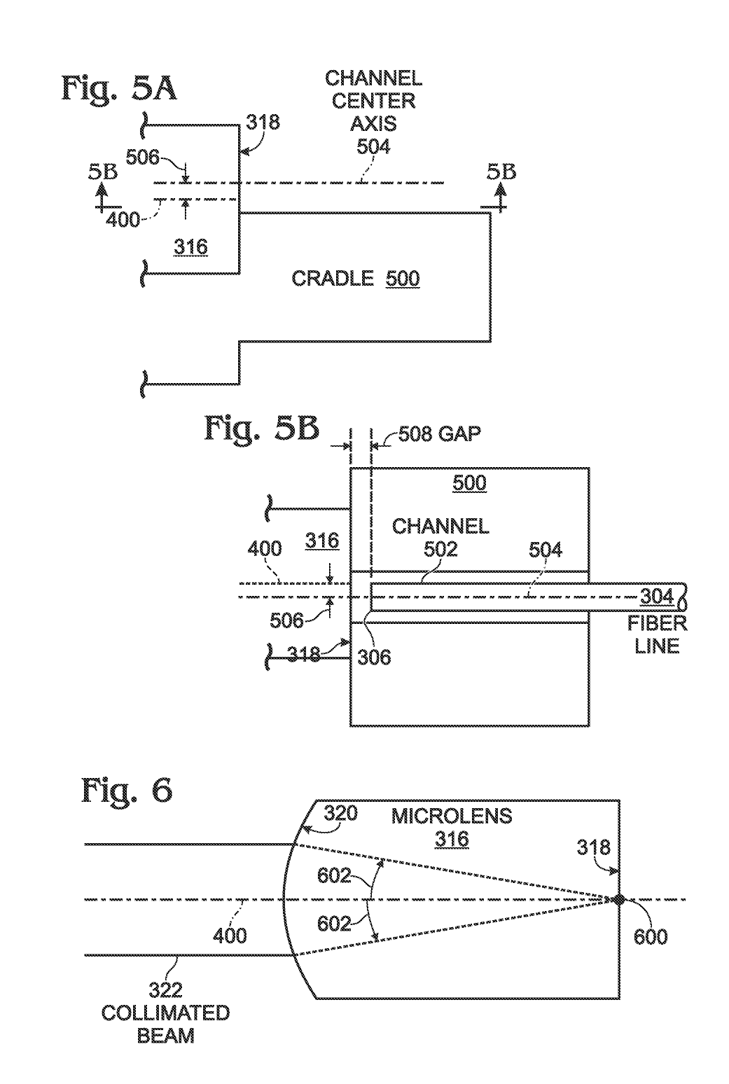

FIGS. 5A and 5B are partial cross-sectional and plan views, respectively, of the first plug of FIG. 3. A first plug cradle 500 has a channel or groove 502 to accept the fiber optic line first end 306 (not shown in FIG. 5A). The channel 502 has a center axis 504 with a tolerance 506 of up to 30 microns with respect to the lens center axis 400. Alternately stated, the center axis of the fiber line core may have a tolerance of up to 30 microns with respect to the lens center axis. The first plug includes a gap 508 between the microlens planar surface 318 and the first fiber optic cable first end of up to 0.4 mm. The second plug (not shown) likewise has a cradle, channel, dimensions, and tolerance as described above.

FIG. 6 is a partial cross-sectional view of the first plug microlens of FIG. 3. The first plug microlens modifies the magnification of light between the collimated beam 322 at convex surface 320 and a point 600 on the planar surface 318 along the lens center axis 400, forming a cone with an angle 602 of 10 to 11 degrees with respect the lens center axis 400. The second plug (not shown) likewise has the same magnification/demagnification features as the first plug microlens.

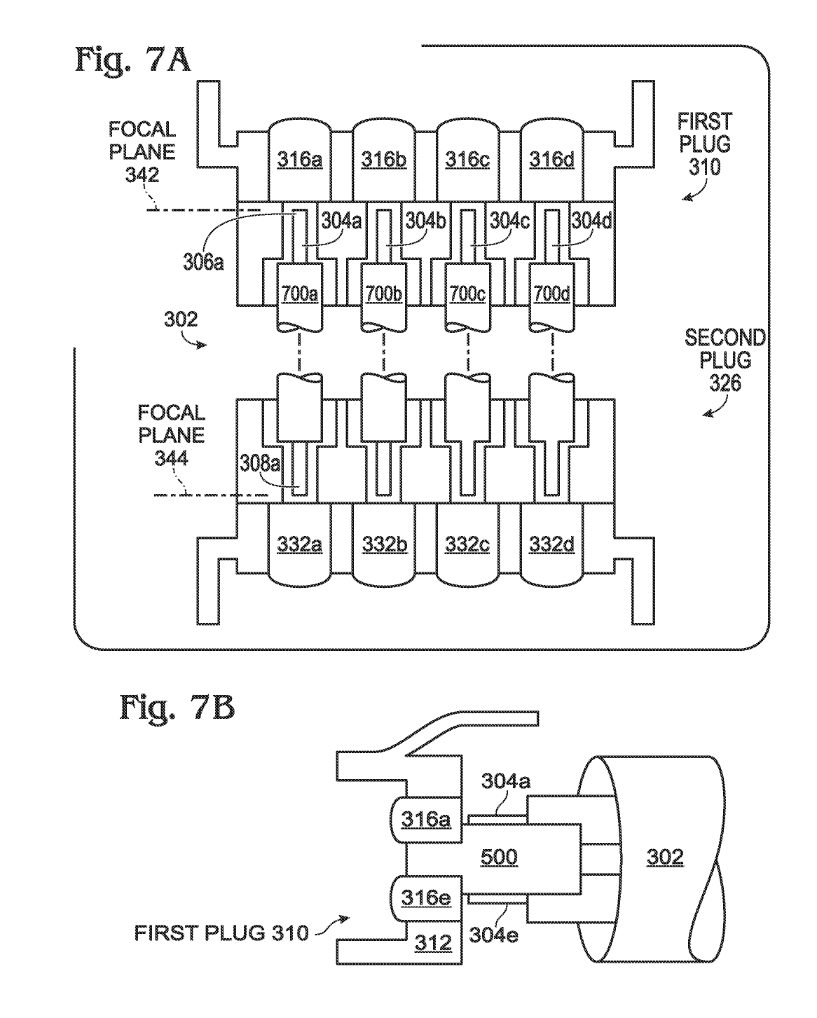

FIGS. 7A and 7B are drawings depicting a fiber optic cable with a cable section that includes a first plurality of fiber optic lines. In FIG. 7A, lines 304a through 304d are shown. Each fiber optic line 304 has a first end 306 and a second end 308. In the example of FIG. 7A, the first plurality is equal to four, but the cable section 302 is not limited to any particular number of lines. The first and second plugs 310/326 include the first plurality of microlenses, respectively 316a-316d and 332a-332d. Each microlens 316/332 has a planar surface 318/334 to engage a corresponding fiber optic line end and a convex surface 320/336 to transceive light in a corresponding collimated beam with a jack optical interface (not shown). Each fiber optic cable end 306/308 is formed in a focal plane 342/344 of a corresponding first plug microlens 316/332. A layer of cladding 700 is also shown surrounding the fiber cores 304. In one aspect the cladding diameter is about 0.49 mm and the core diameter is about 0.0625 mm. Typically, the cladding is covered with a buffer and plenum jacket, which is not shown because it is stripped away.

As shown in FIG. 7B, there may be multiple rows of microlenses, e.g., a top row and a bottom row. Note: a completely assembled plug would include top and bottom crimping plates (not shown), to secure the fiber lines 304 to the cradle 500. In one aspect, the first plug mechanical body has the form factor of an 8 Position 8 Contact (8P8C) plug mechanical body.

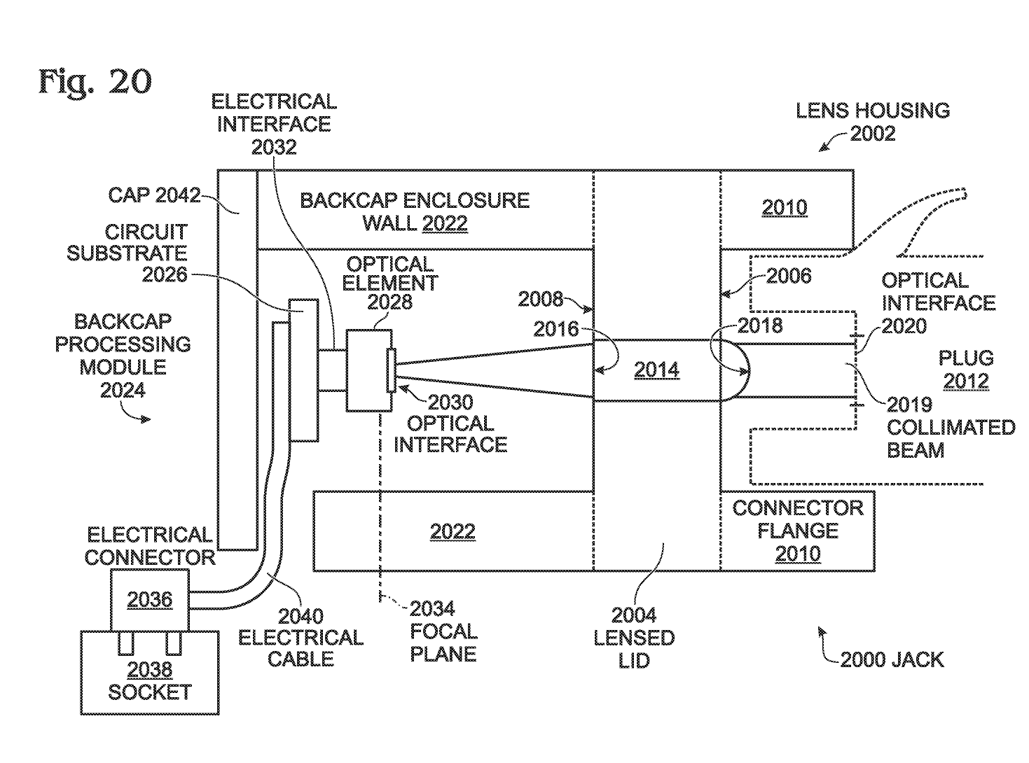

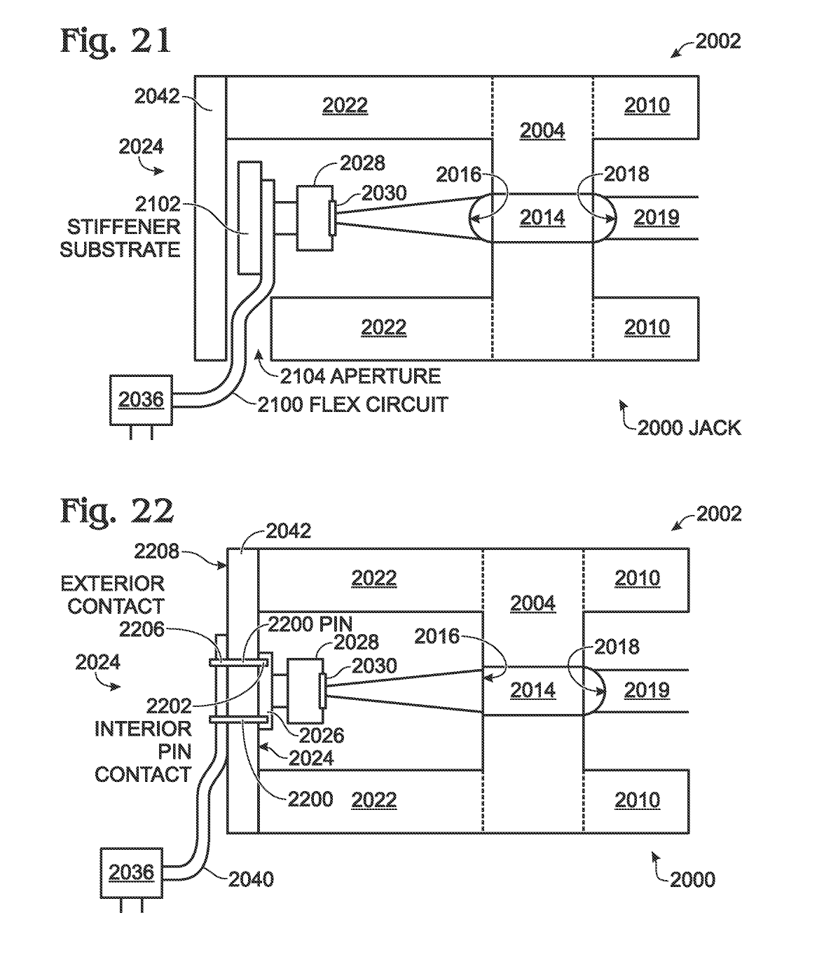

FIG. 20 is a partial cross-sectional view depicting a fiber optic jack with backcap processing module. The jack 2000 comprises a lens housing 2002 having a lensed lid 2004 with a top surface 2006 and a bottom surface 2008. A connector flange 2010 extends from the lensed lid top surface 2006, and is shaped to selectively engage and disengage a plug connector housing (in phantom) 2012. For example, the connector flange 2010 may engage the plug of FIG. 3. A microlens 2014 has a first surface 2016 formed in the lensed lid bottom surface 2008, and a convex surface 2018 formed in the lensed lid top surface 2006 to transceive light in a collimated beam 2019 with a plug optical interface 2020. In one aspect as shown, the microlens first surface 2016 is planar. Alternately as shown in FIG. 21, the first surface is convex. A backcap enclosure wall 2022 extends from the lensed lid bottom surface 2008. In one aspect as shown, the lens housing 2002 is a single injection molded piece made from a polycarbonate resin thermoplastic such as lexan or ultem.

A backcap processing module 2024 includes a circuit substrate 2026. An optical element 2028 has an electrical interface (e.g., pins) 2032 connected to the circuit substrate 2026, and an optical interface 2030 formed in a focal plane 2034 of the microlens 2014 to transceive light with the microlens first surface 2016. In one aspect, the microlens 2014 has a focal length in a range of 2 to 4 mm. The optical element 2028 may be a vertical-cavity surface-emitting laser (VCSEL) to transmit light, or a photodiode (PD) to receive light.

An electrical connector 2036, external to the backcap processing module, selectively engages and disengages from a printed circuit board (PCB) socket 2038. An electrical cable or wire harness 2040 carries electrical signals between the circuit substrate 2026 and the electrical connector 2036. The circuit substrate 2026 includes surface and/or interlevel electrical traces, which may connect the optical element 2032 to power, ground, and the electrical cable 2040—to communicate electrical signals with the PCB socket 2038. In one aspect not shown, the electrical cable is directly soldered to the PCB (no connector is required). A cap 2042 overlies the backcap enclosure walls 2022.

FIG. 21 is a diagram depicting a first variation of the connector jack of FIG. 20. In this aspect, the circuit substrate and electrical cable are a flex circuit 2100. As is well known, a flex circuit is flexible enough to act as a connector cable, and it may be fabricated with electrically conductive surface and interlevel traces so as to act as a circuit board. In one aspect as shown, the flex circuit 2100 may be mounted on a stiffener substrate 2102. In another aspect not shown, the flex circuit may be mounted on the cap 2042. Also shown is an aperture 2104 formed in the backcap enclosure wall 2022. The electrical cable (i.e. flex circuit 2100) passes through the aperture 2104.

FIG. 22 is a diagram depicting a second variation of the connector jack of FIG. 20. In this aspect, the cap 2042 includes connection pins 2200, where each pin 2200 has an interior contact 2202 on an interior surface 2204 of the cap 2042 and an exterior contact 2206 on an exterior surface 2208 of the cap. The circuit substrate 2026 is mounted on the cap interior surface 2204 and connected to the interior contacts 2202. The electrical cable 2040 is connected to the exterior contacts 2206.

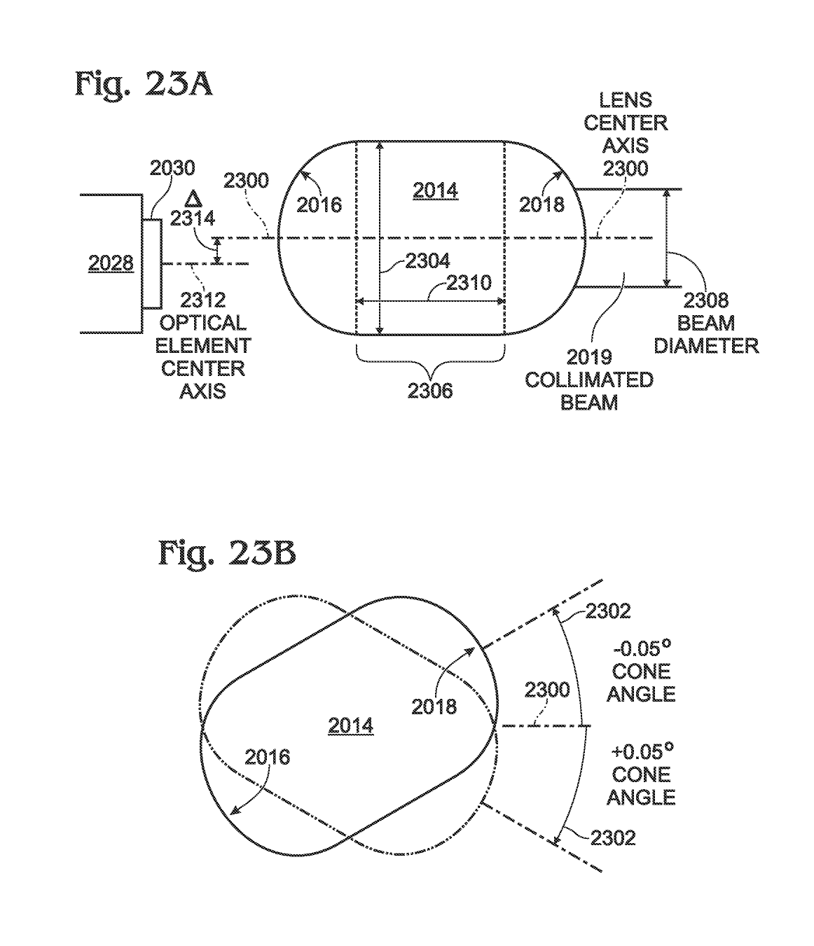

FIGS. 23A and 23B are a more detailed depiction of the plug microlens of FIG. 20. The microlens 2014 has a lens center axis 2300. As shown in FIG. 23B, there is a lens axis tolerance defined by a cone angle 2302 of up to 0.5 degrees (+/−0.5 degrees from a perfectly aligned, or tolerance midpoint lens center axis) as a result of the jack connector flange tolerances, when engaging a plug mechanical body. That is, due to “play” between the jack and plug housings, resulting from design and manufacturing tolerances, the lens axis may be misaligned as much as 0.5 degrees. Note: although misalignment is only shown in an XY plane, the lens axis tolerance may define a circular cone with respect to a perfectly aligned center axis.

The microlens 2014 has a diameter 2304 in the range of 2 to 3 mm, and a collimated beam diameter 2308 of 1.2 to 1.3 mm is transceived within the microlens diameter 2304. The microlens 2014 includes a cylindrical section 2306 interposed between the first surface 2016 and the convex surface 2018.

In one aspect, the first plug microlens cylindrical section 2306 has a length 2310 in the range of 4 to 6 mm and the convex surface 2018 has a radius of curvature in the range of 2 to 3 mm. The first (convex) surface 2016 has a radius of curvature in a range of 0.75 to 2 mm.

Also shown is the optical element 2028 optical interface 2030, which has an optical element center axis 2312 with a decentering tolerance (Δ) 2314 of up to 10 microns, with respect to the lens center axis 2300. Shown is the misalignment between axes 2312 and 2300 in the Y (vertical) plane. The overall decentering combines misalignment in both the X (in/out of the page) and Y planes.

In one aspect, the microlens 2014 modifies the magnification of light between the collimated beam 2019 at the convex surface 2018 and the first surface 2016 by a factor of 0.71. Alternately stated, the microlens magnifies light between the first (convex) surface 2016 and the convex surface 2018 by a factor of (1/0.071=) 1.36.

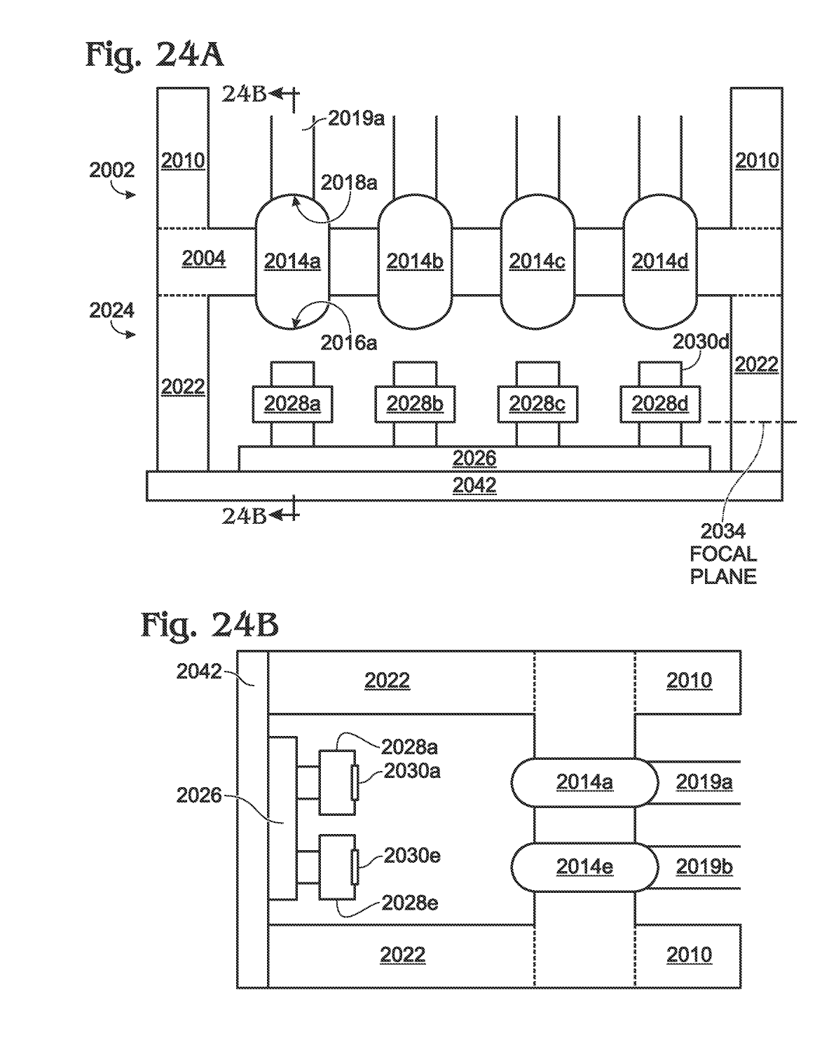

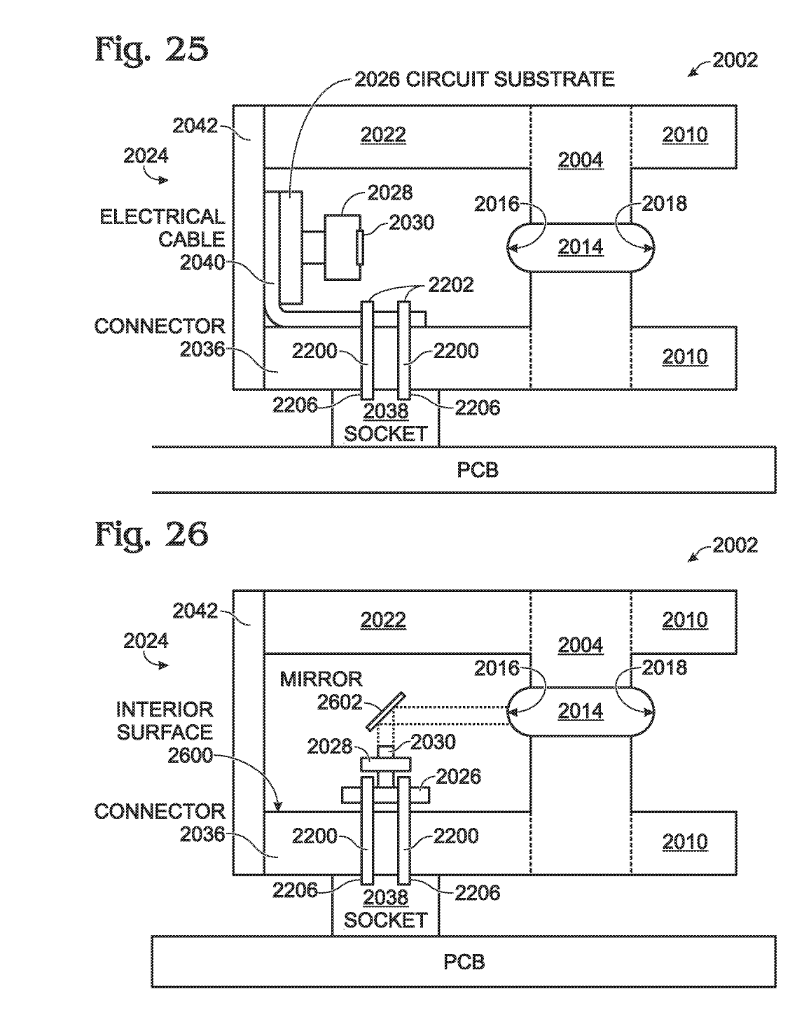

FIGS. 24A and 24B are plan and cross-sectional views, respectively, of a third variation of the jack of FIG. 20. The backcap processing module 2024 includes a first plurality of optical elements 2028. Shown are four PDs, 2028a through 2028d. Alternately but not shown, the optical elements may be VCSELs or combinations of VCSELs and PDs. Note: the backcap processing module is not limited to any particular number of optical elements per row, or any particular number of rows. Likewise, the lensed lid 2004 includes a first plurality (e.g., four) of microlenses 2014a through 2014d. Each plug microlens 2014 has a first surface 2016 to engage a corresponding optical element optical interface 2030 and a convex surface 2018 to transceive light in a corresponding collimated beam 2019 with a plug optical interface (not shown). Each optical interface 2030 is formed in the focal plane 2034 of a corresponding microlens 2014.

As shown in FIG. 24B, there may be multiple rows of microlenses, e.g., a top row and a bottom row. In one aspect, the jack has the form factor of an 8 Position 8 Contact (8P8C) plug mechanical body.

FIG. 25 is a cross-sectional view of a fourth variation of the jack of FIG. 20. In this aspect, the connector 2036 is formed in the backcap enclosure wall 2022, or is rigidly attached to an exterior surface of the enclosure wall 2022. Thus, the jack 2000 can be plugged directly into a PCB socket 2038. In one aspect as shown, the electrical cable 2040 is internal to the backcap processing module, connecting the circuit substrate 2026 to connector 2036. Connection pins 2200 are shown, where each pin 2200 has an interior contact 2202 and an exterior contact 2206. The circuit substrate 2026 is connected to the interior contacts 2202 via the electrical cable 2040, and the exterior contacts 2206 engage the socket 2038.

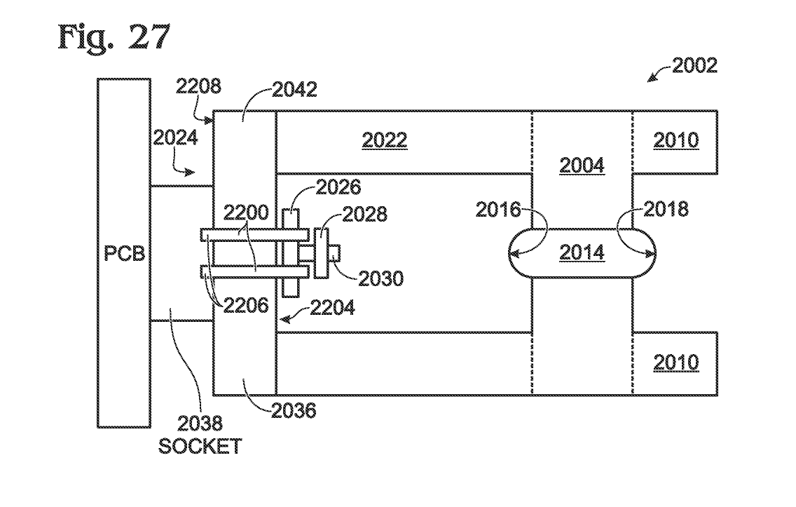

FIG. 26 is a cross-sectional view of a fifth variation of the jack of FIG. 20. As in the jack 2000 of FIG. 25, the connector 2036 is formed in the backcap enclosure wall 2022, or is rigidly attached to an exterior surface of the enclosure wall 2022. The jack 2000 can be plugged directly into a PCB socket 2038. However, is this aspect, the circuit substrate 2026 is mounted on an interior backcap enclosure wall surface 2600. Connection pins 2200 are shown, where each pin 2200 has an interior contact 2202 and an exterior contact 2206. The circuit substrate 2026 is connected to the interior contacts 2202 and the exterior contacts 2206 engage the socket 2038. An electrical cable between the circuit substrate 2026 and the connector 2036 is no longer needed, as in the jack of FIG. 25. However, a mirror 2602 is required to optically connect optical interface 2030 with the microlens first surface 2016.

FIG. 27 is a cross-sectional view of a sixth variation of the jack of FIG. 20. In this aspect, the connector 2036 is formed in the cap 2042, or is rigidly attached to an exterior surface 2208 of the cap 2042. The jack 2000 can be plugged directly into a PCB socket 2038. Connection pins 2200 are shown, where each pin 2200 has an interior contact 2202 and an exterior contact 2206. The circuit substrate 2026 is connected to the interior contacts 2202 and the exterior contacts 2206 engage the socket 2038. An electrical cable between the circuit substrate 2026 and the connector 2036 is no longer needed, as in the jack of FIG. 25. Since the optical line-of-sight between the optical interface 2030 and the microlens first surface 2016 has not been disturbed, no mirrors are required.

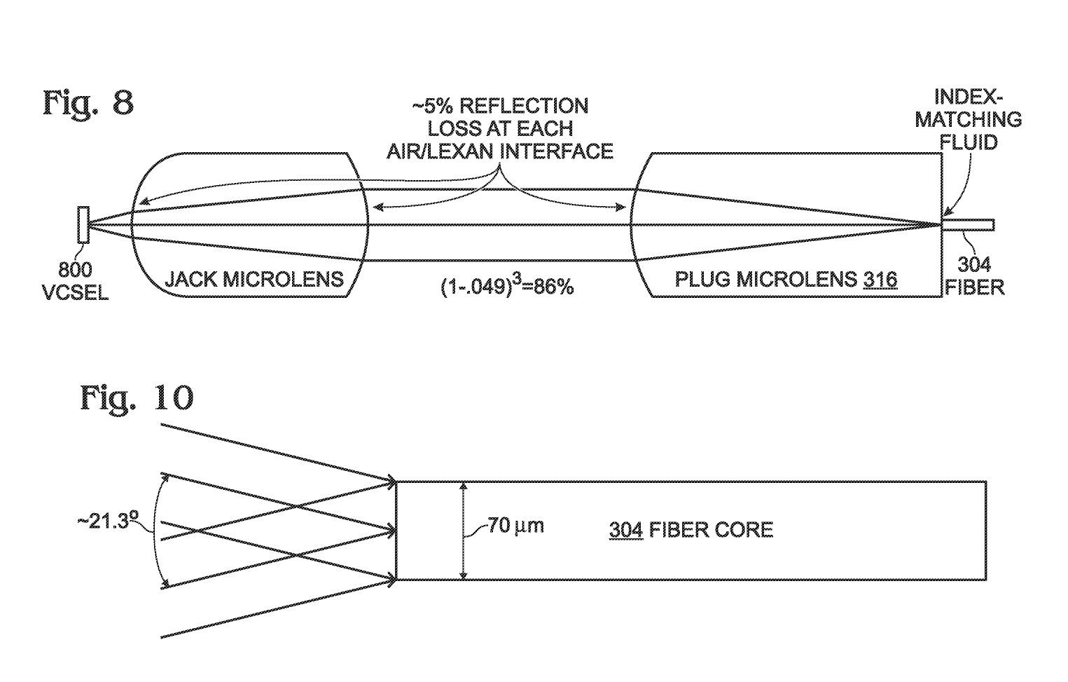

FIG. 8 is a diagram depicting communicating jack and plug microlens. A transmitting vertical-cavity surface-emitting laser (VCSEL) 800 has a numerical aperture (NA) of 0.259, so that light is emitted into a 30 degree cone at the 1/e² point:

NA=1 sin 15°=0.259.

The NA of the fiber line 304 is 0.185, which translates into an acceptance angle cone of about 21 degrees.

One aspect of coupling efficiency is reflection (R). A normally incident reflection of ˜4.9% is typical of each air/lexan interface. For rays not normally incident, R is a function of angle of incidence and polarization:

n for lexan@850 nm˜1.568;

n′ for air=1;

R=((n−n′)/(n+n′))2˜4.9%;

Assuming each jack and plug use a microlens, there are 3 air-to-lexan interfaces. The fiber/plug interface is filled with index-matching fluid, so no reflection is assumed for this interface. The index matching fluid typically has a value in between that of the lens material index and air (1).

(1−0.049)³=86% optimal coupling efficiency.

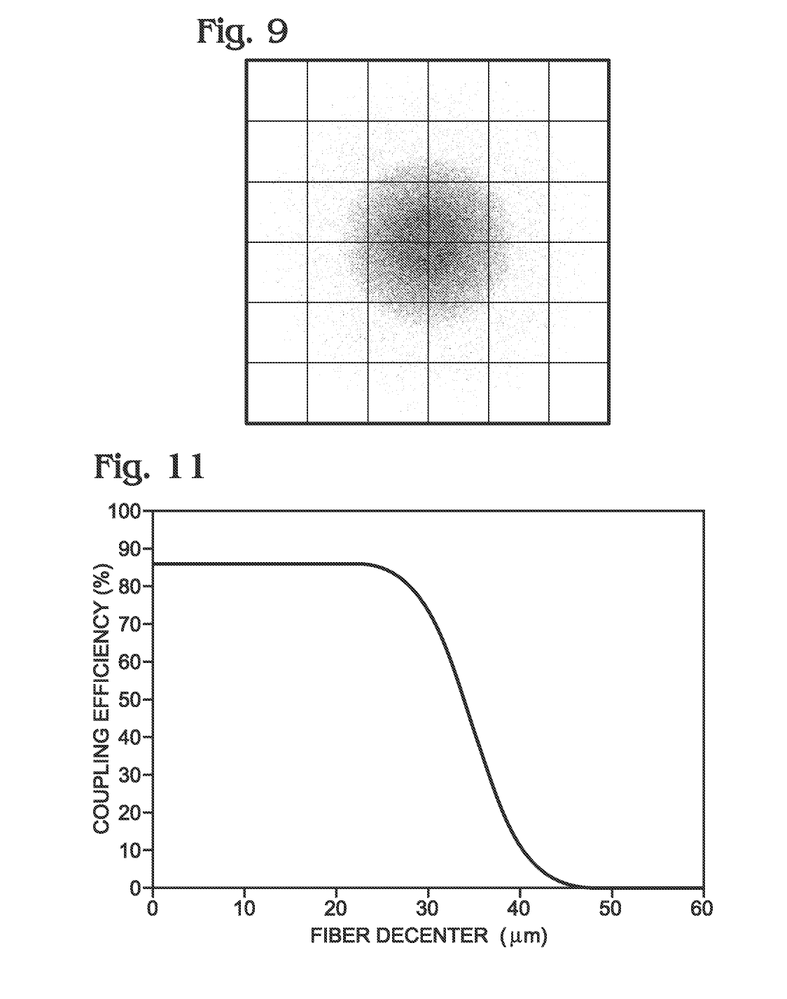

FIG. 9 is a model calculation graphically depicting the coupling efficiency of the system of FIG. 8. The model shows that 86% of the transmitted light falls within a circle of about 0.07 mm, which is about the diameter of a particular POF optical fiber core.

FIG. 10 is a diagram depicting the fiber core acceptance angle. Assuming a 70 micron diameter gradient index (GRIN) fiber core, the NA is 0.185, which translates to an acceptance angle of +/−10.7°. This assumption ignores the fact that the acceptance angle falls off towards to core edges.

Many of the system tolerances can be converted into an effective fiber lateral decenter. For example, VCSEL lateral decentering can be multiplied by the system magnification. Plug tilt can be accounted for by taking the taking the tangent of the tilt and multiplying it by the effective focal length of the plug lens. Most of the other tolerances tend to change the shape of the beam rather than causing the beam to “walk off” the face of the fiber end. With respect to the fiber line of FIG. 10, “lateral” refers to the X plane (in and out of the page) and Y plane (from the page top to the page bottom). The Z plane would be left to right on the page.

FIG. 11 is a graph depicting the relationship between coupling efficiency and fiber lateral decentering (Δ). The relationship is nonlinear, steeply degrading at about 30 microns of decentering, or about half the core diameter.

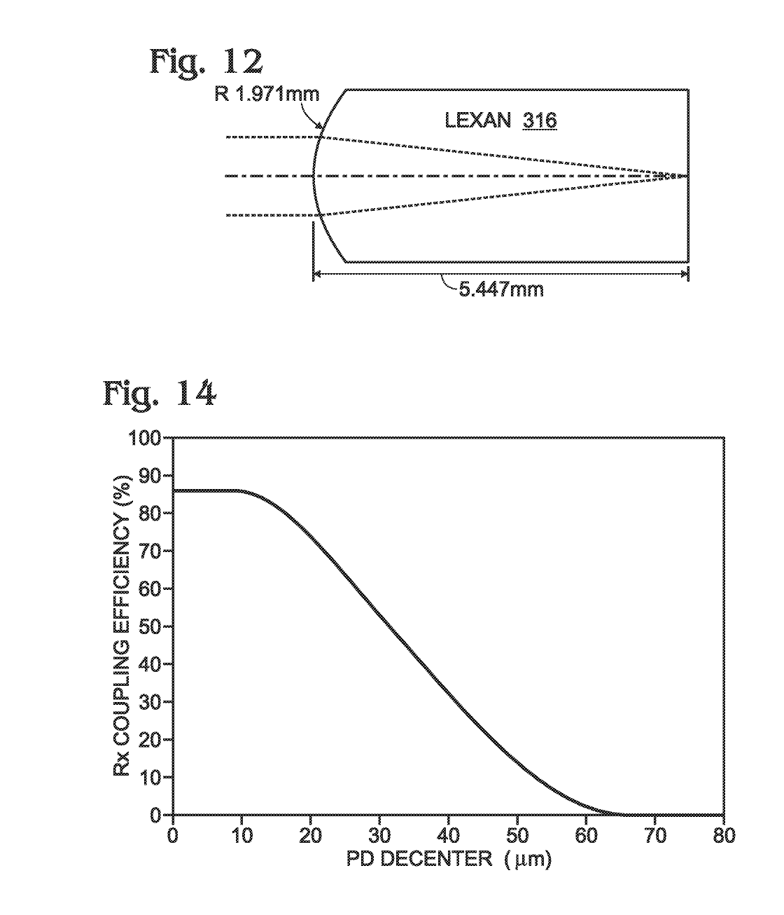

FIG. 12 is a diagram depicting the effective focal length of the plug microlens. Assuming a radius of curvature of 1.971 mm, an overall lens length of 5.447 mm, and a lexan material, the effective focal length of the plug is:

eflplug˜5.447 mm/nₗₑₓₐₙ;

eflplug=3.471 mm.

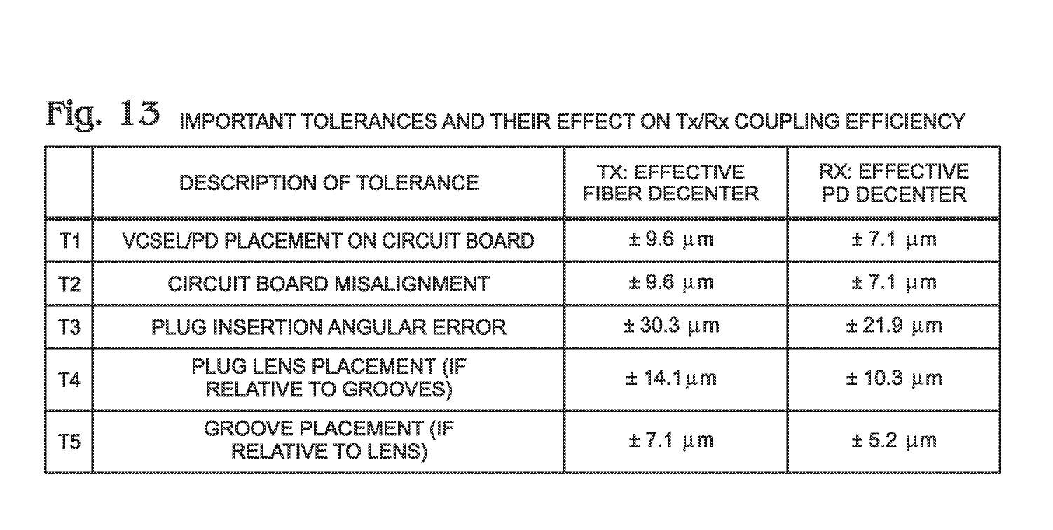

FIG. 13 is a table of tolerances cross-referenced to fiber lateral decentering.

The following is an equation for worst-case effective fiber decentering using tolerances T1 through T5 from the Table of FIG. 13:

$$\begin{matrix}effective fiber decenter = T 1 ( 1.36 ) + T 2 ( 1.36 ) + 3.471 tan ( T 3 ) + T 4 + T 5 ; \\ = 1.36 ( T 1 + T 2 ) + 3.471 [ tan ( T 3 ) ] + T 4 + T 5 \\ ∼ 1.36 ( T 1 + T 2 ) + 3.471 ( T 3 ) + T 4 + T 5\end{matrix}$$

The tolerances T1 and T2 are proportional to the system magnification (1.36), and the lens tilt is expressed as a tangent in radians, assuming a small-angle approximation. Note: T2 circuit misalignment refers to the relationship between the circuit board on which the optical elements (VCSEL and PD) are mounted and the microlens. T1 VCSEL/PD misalignment refers to misalignment between the VCSEL/PD and the circuit board. The T4 and T5 tolerances are outside the system magnification, and need not be system normalized.

In matrix form the equation is:

$$[ \begin{matrix}T 1 & T 2 & T 3 & T 4 & T 5\end{matrix} ] [ \begin{matrix}1.36 \\ 1.36 \\ 3.471 \\ 1 \\ 1\end{matrix} ]$$

where
1.36=current system magnification;
3.471 mm=plug focal length; and,
Ti=ith tolerance.

FIG. 14 is a graph depicting coupling efficiency as a function of photodiode (PD) decentering.

FIG. 15 is a diagram depicting the relationship between fiber decentering and lens tilt.

$$\begin{matrix}Δ = effective fiber decenter = fplug * tan θ ; \\ = 3.471 mm * tan θ ;\end{matrix}$$

If θ=0.5°, then Δ=30.3 μm. Note: the angle θ has been exaggerated.

FIG. 16 is a diagram depicting the relationship between PD decentering and lens tilt.

$$\begin{matrix}Δ = effective PD decenter = fjack * tan θ \\ = 2.504 mm * tan θ\end{matrix}$$

If θ=0.5°, then Δ=21.9 μm.

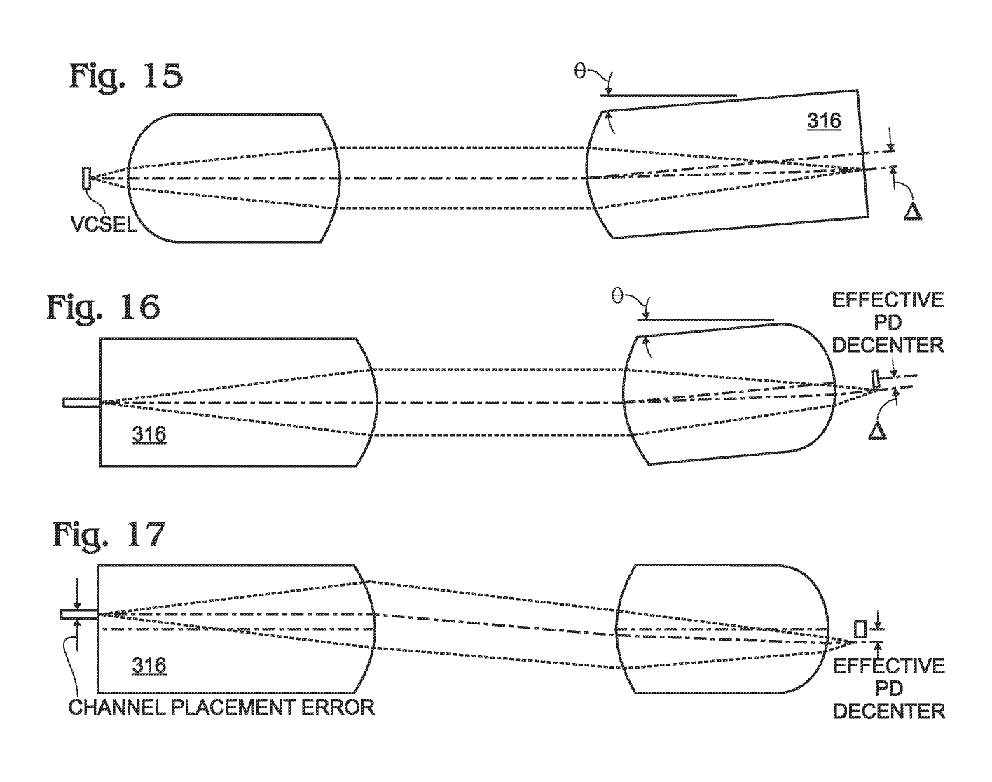

FIG. 17 is a diagram depicting the relationship between PD decentering and groove (channel) placement error. The channel placement error may also be understood as a lens placement error relative to the channel.

The effective PD decenter=channel placement error*Msys;

where Msys is the system magnification (0.727=1/1.36).

A channel placement error of 7.1 μm results in effective PD decentering of 7.1 μm*0.727=5.2 μm in both the X and Y planes. The overall decentering (the hypotenuse of the triangle) is:

sqrt(5²+5²)=7.1 microns.

A placement error of 10 microns results in a PD decentering of about 10 microns.

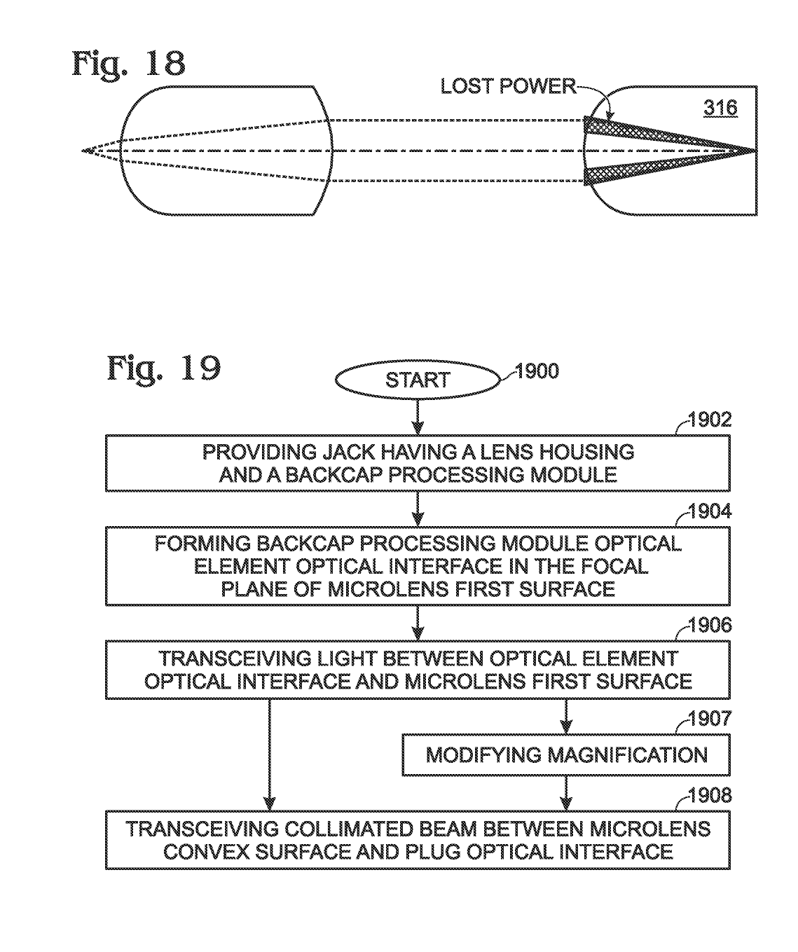

FIG. 18 is a diagram depicting the consequences of shortening the focal length of the plug, without a corresponding change in the jack lens. If the plug focal length (fplug) is decreased, the loss in coupling efficiency due to plug angular misalignment can be reduced. However, the fiber core would be overfilled (exceeding the NA 0.185), which would result in some lost energy.

FIG. 19 is a flowchart illustrating a method for transceiving a collimated beam of light with a fiber optic cable jack connector. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the steps are performed in numerical order. The method starts at Step 1900.

Step 1902 provides a jack connector having a lens housing including a lensed lid with a connector flange to selectively engage and disengage a plug connector housing, a microlens formed in the lensed lid having a first surface and a convex surface, and a backcap enclosure wall extending from the lensed lid bottom surface. A backcap processing module includes a circuit substrate, an optical element electrically connected to the circuit substrate and an optical interface formed in a focal plane of the microlens, and a cap overlying the backcap enclosure walls.

Step 1904 forms an optical interface of the optical element in a focal plane of the microlens first surface. Step 1906 transceives light between the optical element optical interface and the microlens first surface. Step 1908 transceives a collimated beam of light between the microlens convex surface and a plug optical interface. In one aspect, in Step 1907, the microlens modifies the magnification of light between the collimated beam at the convex surface and the first surface by a factor of 0.71.

In one aspect, transceiving the collimated beam of light with the microlens convex surface in Step 1908 includes creating a collimated beam with a tolerance defined by a cone angle of up to 0.5 degrees, with respect to a lens center axis, as a result of lens housing tolerances, when engaging a plug mechanical body.

In another aspect, forming the optical interface of the optical element in the focal plane of the microlens first surface in Step 1904 includes the microlens having a focal length in a range of 2 to 4 mm.

A fiber optic cable and plug connector have been provided.

Some examples of particular housing designs, tolerances, and dimensions have been given to illustrate the invention. However, the invention is not limited to merely these examples. Other variations and embodiments of the invention will occur to those skilled in the art.

We claim:

1. A fiber optic connector jack with backcap processing module comprising:
a lens housing including:
a lensed lid with a top surface and a bottom surface;
a connector flange extending from the lensed lid top surface, shaped to selectively engage and disengage a plug connector housing;
a microlens having a first surface formed in the lensed lid bottom surface, and a convex surface formed in the lensed lid top surface to transceive light in a collimated beam with a plug optical interface;
a backcap enclosure wall extending from the lensed lid bottom surface;
a backcap processing module including:
a circuit substrate;
an optical element having an electrical interface connected to the circuit substrate, and an optical interface formed in a focal plane of the microlens to transceive light with the microlens first surface;
an electrical connector external to the backcap processing module for selectively engaging and disengaging from a printed circuit board (PCB) socket;
an electrical cable for carrying electrical signals between the circuit substrate and the electrical connector; and,
a cap overlying the backcap enclosure walls.

2. The jack of claim 1 wherein the circuit substrate and electrical cable are a flex circuit.

3. The jack of claim 2 wherein the backcap enclosure wall includes an aperture; and,
wherein the flex circuit passes through the aperture.

4. The jack of claim 1 wherein the microlens first surface is selected from a group consisting of planar and convex surfaces.

5. The jack of claim 1 wherein the microlens has a lens center axis, and a lens axis tolerance defined by a cone angle of up to 0.5 degrees as a result of the connector flange tolerances, when engaging a plug mechanical body.

6. The jack of claim 5 wherein the optical element optical interface has a center axis with a decentering tolerance of up to 10 microns, with respect to the lens center axis.

7. The jack of claim 1 wherein the microlens transceives the collimated beam with a beam diameter in a range of 1.2 to 1.3 mm.

8. The jack of claim 7 wherein the microlens has a diameter in a range of 2 to 3 mm, and wherein the collimated beam diameter is transceived within the microlens diameter.

9. The jack of claim 1 wherein the microlens includes a cylindrical section interposed between the first surface and the convex surface.

10. The jack of claim 9 wherein the microlens cylindrical section has a length in a range of 4 to 6 mm, the convex surface has a radius of curvature in a range of 2 to 3 mm, and the first surface is convex having a radius of curvature in a range of 0.75 to 2 mm.

11. The jack of claim 1 wherein the backcap processing module includes a first plurality of optical elements;
wherein the lensed lid includes a first plurality of microlenses, each plug microlens having a first surface to engage a corresponding optical element optical interface and a convex surface to transceive light in a corresponding collimated beam with a plug optical interface; and,
wherein each optical interface is formed in a focal plane of a corresponding microlens.

12. The jack of claim 1 wherein the lens housing is a single injection molded piece made from a polycarbonate resin thermoplastic selected from a group consisting of lexan and ultem.

13. The jack of claim 1 wherein the microlens has a focal length in a range of 2 to 4 mm.

14. The jack of claim 1 wherein the microlens modifies the magnification of light between the collimated beam at the convex surface and the first surface by a factor of 0.71.

15. The jack of claim 1 wherein the optical element is selected from a group consisting of a vertical-cavity surface-emitting laser (VCSEL) and a photodiode (PD).

16. The jack of claim 1 wherein the cap includes connections pins, where each pin has an interior contact on an interior surface of the cap and an exterior contact on an exterior surface of the cap;
wherein the circuit substrate is mounted on the cap interior surface and connected to the interior contacts; and,
wherein the electrical cable is connected to the exterior contacts.

17. A method for transceiving a collimated beam of light with a fiber optic cable jack connector, the method comprising:
providing a jack connector including:
a lens housing including a lensed lid with a connector flange to selectively engage and disengage a plug connector housing, a microlens formed in the lensed lid having a first surface and a convex surface, and a backcap enclosure wall extending from the lensed lid bottom surface;
a backcap processing module including a circuit substrate, an optical element electrically connected to the circuit substrate and an optical interface formed in a focal plane of the microlens, and a cap overlying the backcap enclosure walls;
forming an optical interface of the optical element in a focal plane of the microlens first surface;
transceiving light between the optical element optical interface and the microlens first surface; and,
transceiving a collimated beam of light between the microlens convex surface and a plug optical interface.

18. The method of claim 17 wherein transceiving the collimated beam of light with the microlens convex surface includes creating a collimated beam with a tolerance defined by a cone angle of up to 0.5 degrees, with respect to a lens center axis, as a result of lens housing tolerances, when engaging a plug mechanical body.

19. The method of claim 17 wherein forming the optical interface of the optical element in the focal plane of the microlens first surface includes the microlens having a focal length in a range of 2 to 4 mm.

20. The method of claim 17 further comprising:
the microlens modifying the magnification of light between the collimated beam at the convex surface and the first surface by a factor of 0.71.

21. A fiber optic connector jack with backcap processing module comprising:
a lens housing including:
a lensed lid with a top surface and a bottom surface;
a connector flange extending from the lensed lid top surface, shaped to selectively engage and disengage a plug connector housing;
a microlens having a first surface formed in the lensed lid bottom surface, and a convex surface formed in the lensed lid top surface to transceive light in a collimated beam with a plug optical interface;
a backcap enclosure wall extending from the lensed lid bottom surface;
a backcap processing module including:
a circuit substrate;
an optical element having an electrical interface connected to the circuit substrate, and an optical interface formed in a focal plane of the microlens to transceive light with the microlens first surface;
an electrical connector formed on an external surface of the backcap processing module for selectively engaging and disengaging from a printed circuit board (PCB) socket; and,
a cap overlying the backcap enclosure walls.
